(19) United States
(12) Patent Application Publication
(10) Pub. No.: US 2012/0316999 A1
(43) Pub. Date: Dec. 13, 2012

(54) SYSTEMS, DEVICES, AND METHODS FOR VIRTUAL COLLECTIBLE GENERATION, TRADING, PURCHASING, AND MANAGEMENT

(75) Inventors: Alan S. Koh, Chicago, IL (US); Robert Williams, Naperville, IL (US)

(73) Assignee: HYBRID ORBITAL, Chicago, IL (US)

(21) Appl. No.: 13/158,642

(22) Filed: Jun. 13, 2011

(51) Int. Cl. G06Q 30/00; G06F 17/30; G06T 15/00

(52) U.S. Cl. 705/27.2; 345/419; 707/812; 707/E17.005

(57) ABSTRACT

Embodiments of the disclosure include systems, methods, and devices for generating, purchasing, and managing virtual collectibles (VCs) using a software platform. Embodiments take advantage of the capabilities of the Internet as a medium for users to exchange goods and couples the recent advancement in 3-D rendering technology to provide a virtual marketplace for collectors to purchase, sell, trade and manage (manipulate and control) VCs. Aspects of the disclosure include generating a VC by scanning a physical collectible, rendering a 3-D digital copy of the physical collectible, and enhancing virtual characteristics of the 3-D digital copy. A unique encrypted digital string may be generated based on the virtual characteristics. Also, unique digital string may be encoded into virtual characteristics such that the VC is the enhanced 3-D digital copy of the physical collectible encoded with the unique digital string.

### BACKGROUND

As has been widely discussed for years, the Internet has provided an unprecedented way in which to provide and gather information from across the world. The Internet has evolved from being an information resource to consumer and companies to becoming a way for consumer and companies to conduct business. To that extent, the Internet has brought about a fundamental change in the way goods are exchanged. E-commerce, which includes using the Internet as a storefront showing an e-merchant's products and/or services, has evolved in complexity and features over the years. For example, Amazon was the first prominent e-retailer and focused on selling only books on the Internet. After initial success, Amazon expanded its site's features and complexity, not only by introducing new product lines such as electronics and apparel, but also providing a marketplace for user to sell their own items to each other.

Recently, e-commerce has included the distribution of digital goods such as music in the form of mp3 files and video files in the form of mpeg (or some other video format). These digital goods are gathered by user for personal enjoyment. Alternatively, the Internet has become a place for a virtual reality such as in the form of video gaming. In such virtual environments, digital goods are gathered by the user as part of an object of the game and are not consumed or enjoyed directly by the user as in viewing digital music or videos.

Gathering collectibles (e.g. stamps, sports cards, comic books, action figures, etc.) is hobby enjoyed by many people worldwide. Traditionally, collectibles have been tangible, physical objects that have some degree of scarcity, whether it be when the physical collectible was first manufactured or by having a significant number of the physical collectible to be lost over the years. An increase in the degree of scarcity increases the value of the collectibles.

In addition, computer graphics technology has advanced in recent years. Three-dimensional (3-D) rendering capability of physical objects as well as 3-D graphics compression has enabled boarder application of 3-D technology in the areas of entertainment, computer gaming, multimedia, and e-commerce.

### BRIEF SUMMARY

Embodiments of the disclosure include systems, methods, and devices for generating, purchasing, and managing virtual collectibles using a software platform. Embodiments take advantage of the capabilities of the Internet as a medium for users to exchange goods and couples the recent advancement in 3-D rendering technology to provide a virtual marketplace for collectors to purchase, sell, trade and manage (manipulate and control) virtual collectibles. Aspects of the disclosure include generating a virtual collectible by scanning a physical collectible using a scanning device and then rendering a three-dimensional (3-D) digital copy of the physical collectible using one or more software applications that may be part of the software platform executed on a computer server. Further, exemplary systems, methods or devices may enhance one or more virtual characteristics of the 3-D digital copy of the physical collectible using the one or more software applications. In addition, a unique encrypted digital string may be generated based on the one or more virtual characteristics of the 3-D digital copy of the physical collectible using the one or more software applications. Also, unique digital string may be encoded into one of the one or more virtual characteristics of the 3-D digital copy of the physical collectible such that the virtual collectible is the enhanced 3-D digital copy of the physical collectible encoded with the unique digital string.

Aspects of the disclosure may include purchasing a virtual collectible by receiving a purchase request of the virtual collectible from an application programming interface such that the purchase request associated with a user. Further, the availability of the virtual collectible is determined by analyzing one or more databases using one or more software applications. In addition, the purchase request for the virtual collectible may be processed and a unique string associated with the virtual collectible is determined using one or more software applications. Also, user identifier information may be encoded with the unique string to generate a user unique string for the virtual collectible using one or more software applications and the user unique string may be associated to the virtual collectible using one or more software applications.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is an exemplary network using a software platform for generating, purchasing, and managing one or more virtual collectibles;

FIG. 2 is an exemplary functional block diagram of a computer server used in implementing a software platform for generating, purchasing, and managing one or more virtual collectibles;

FIG. 3 is an exemplary functional block diagram of a client computing device used in implementing a software platform for purchasing, and managing one or more virtual collectibles;

FIG. 4 is an exemplary flowchart showing an example method for generating a virtual collectible;

FIGS. 5 and 6 are exemplary flowcharts showing example methods for purchasing a virtual collectible;

FIGS. 7-17 are exemplary screenshots of an example software platform and example client software for purchasing and managing virtual collectibles;

FIGS. 18-20 are exemplary flowcharts that show embodiments of the virtual VC marketplace.

### DETAILED DESCRIPTION OF THE INVENTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

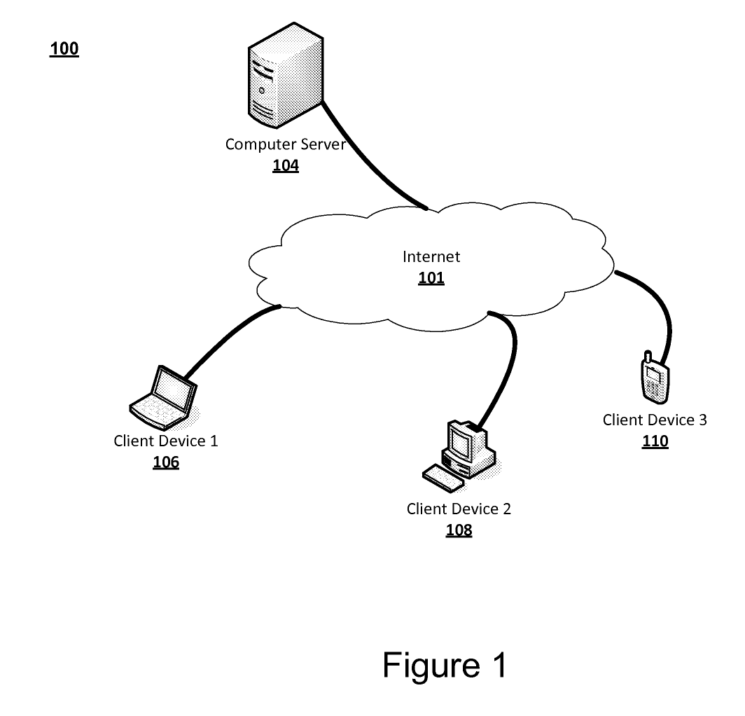

FIG. 1 is an exemplary network 100 using a software platform for generating, purchasing, and managing one or more virtual collectibles. The software platform may reside and be executed by a computer server 104. Before the purchasing and managing of the virtual collectibles, the software platform may be used in conjunction with a scanning device (not shown) to scan a physical collectible such as an action figure to produce a 3-D digital copy of the physical collectible. Such a 3-D digital copy may be processed to generate a virtual collectible and stored in one or more electronic databases. Once a number of virtual collectibles are generated and stored in the electronic databases, one or more users may purchase and manage virtual collectibles using the software platform as well as client software. Thus, the software platform generates a virtual marketplace for users to purchase, sell, trade and manipulate (or otherwise control) VCs. Referring to FIG. 1, a user may access the software platform on computer server 104 across the Internet 101 using a laptop computer as a client device 106, a desktop computer 108, or a mobile phone 110. Other types of client devices may also include tablet computers, video game systems, television, blu-ray disc or DVD players, or any other Internet ready device that can access the software platform.

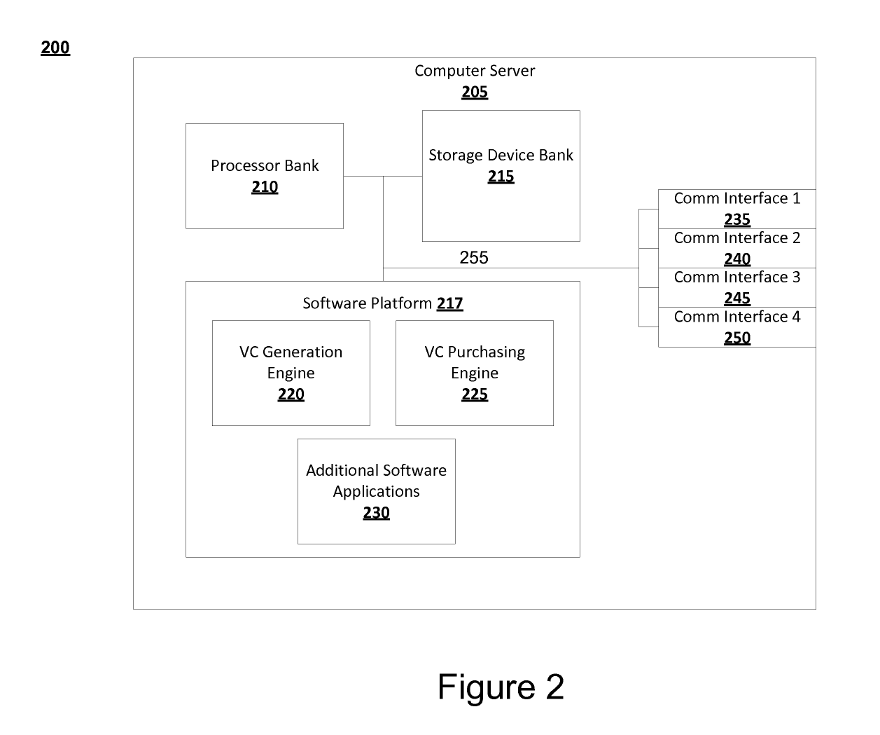

FIG. 2 is an exemplary functional block diagram 200 of a computer server 205 used in implementing a software platform for generating, purchasing, and managing one or more virtual collectibles. The computer server 205 may include several different components such as a processor bank 210, storage device bank 215, one or more software applications 217, and one or more communication interfaces (235-250). The processor bank 210 may include one or more processors that may be co-located with each other or may be located in different parts of the computer server 205. The storage device bank 215 may include one or more storage devices. Types of storage devices may include memory devices, electronic memory, optical memory, and removable storage media. The one or more software applications 217 may include a virtual collectible (VC) generation engine 220, a VC purchasing engine 225, and additional software applications 230. The control software applications may implement software functions that assist in performing certain tasks for the computer server 205 such as providing access to a communication network, executing an operating system, managing software drivers for peripheral components, and processing information. The additional software applications may include control software application that implement software functions that assist in performing certain tasks for the computer server 205 such as providing access to a communication network, executing an operating system, managing software drivers for peripheral components, and processing information. Additional software application may also include software drivers for peripheral components, user interface computer programs, debugging and troubleshooting software tools.

The VC generation engine 220 may be coupled to a scanning device through one of the communication interfaces (235-250). The scanning device (not shown) may scan a physical collectible (e.g. action figure) and render a 3-D digital copy of the physical collectible. The VC generation engine may receive the 3-D digital copy of the physical collectible and process the 3-D digital copy by for example, enhancing virtual characteristics of the 3-D digital copy. Such enhancements may include optimizing and texturing the 3-D digital copy. In addition, the VC generation engine 220 may generate a unique digital string associated with the enhanced 3-D digital copy of the physical collectible. The unique digital string may be encrypted as well as may be based on the certain geometrical and texture, or other virtual characteristics of the 3-D digital copy of the physical collectible. Further, the VC generation engine may encode the unique digital string into the 3-D digital copy of the physical collectible. A virtual collectible is the enhanced 3-D digital copy of the physical collectible encoded with the unique digital string. The unique digital string can be used to verify the authenticity of the virtual collectible. As discussed previously, value of physical collectibles increase with an increase degree of scarcity. Same may be true for virtual collectibles. Thus, the unique digital string for a certain type of VC may include the data that shows the number of VCs of that particular type. For example, a Cobra Commander action figure may be scanned to be a virtual collectible. The software platform may generate only 1,000 copies of the Cobra Commander VC. Thus, the unique digital string associated with each Cobra Commander VC may include data that shows that only 1,000 Cobra Commander VCs have been generated.

The VC may have several embodiments. One embodiment may include that the VC is rendered 360 degrees in 9 degree increments at two different resolutions (e.g. 100×100 pixels and 320×240 pixels). The file associated with the VC may be in a variety of formats such as PNG, GIF, or JPG. Further, VCs may be exported in different resolutions (e.g. polygonal mesh density) for varying levels of client device computing performance. The VC generation engine 220 may also generate a unique identifier for each type of VC. In addition, the VC generation engine may store the VC in one or more electronic databases and associate the unique identifier to the VC when storing the VC. Generated VCs are initially owned by the owner of the virtual marketplace for VCs generated by the software platform. Subsequently, user of the virtual marketplace for VCs may purchase the VCs from the owner of the virtual marketplace. In addition, users may purchase or trade VCs from each other within the VC virtual marketplace generated by the software platform. A person of ordinary skill in the art would understand that the VC generation engine may comprise of one or more software applications.

The VC purchasing engine 225 includes one or more software applications that facilitate the purchasing and/or trading of a VC by the user from the owner of the VC virtual marketplace or from other users. The VC purchasing engine 225 executed on the computer server may receive a purchasing request through an application programming interface (API) from a client computing device. The VC purchasing engine examines the request to determine the VC requested for purchase and the availability of the VC. If the VC is not available, then the VC purchasing engine 225 sends a response indicating the unavailability of the VC. For example, a particular VC may have only 1,000 copies and all of them were previously sold prior to receiving the pending purchase request. Alternatively, another user may own the requested VC but the owner of the VC does not want to sell the VC at this time. However, if the VC is available, the VC purchasing engine 225 processes the purchase request. In addition, the VC purchasing engine 225 determines or extracts the unique digital string from the VC that may be embedded in one of the virtual characteristics (e.g. primary texture). Further, a user identifier is encoded into the unique digital string by VC purchasing engine 225 resulting in a user unique string and is associated to the VC. The unique user string and the record of the purchase is stored in one or more electronic databases and one unit for the VC purchased is deducted from the VC availability records by the VC purchasing engine 225. In addition, additional software applications 230 may include a software application that caches the VC on the user system or client computing device so that the purchased VC may be efficiently accessed by the user in the future.

Additional software applications may include a software application the processes VC access requests received from a client computing device. While processing the access request, the software application determines whether the VC indicated in the access request is purchased by the user. If the user does own the VC, then the software application provides instructions to the client computing device to allow the user a set of controls to manipulate the VC such as moving and viewing the VC, interacting with other VCs, displaying the VC in a virtual environment, etc. However, if the user does not own the VC, the software application provides instructions to the client computing device that allows the user a subset of controls for the VC. For example, the user may only view the VC and determine the value of the VC.

Each of the communication interfaces (235-250) shown in FIG. 2 may be software or hardware associated in communicating to other devices. The communication interfaces (235-250) may be of different types that include a user interface, USB, Ethernet, WiFi, WiMax, wireless, optical, cellular, or any other communication interface coupled to communication network.

An intra-device communication link 255 between the processor bank 210, storage device bank 215, software applications 225, and communication interfaces (230-245) may be one of several types that include a bus or other communication mechanism.

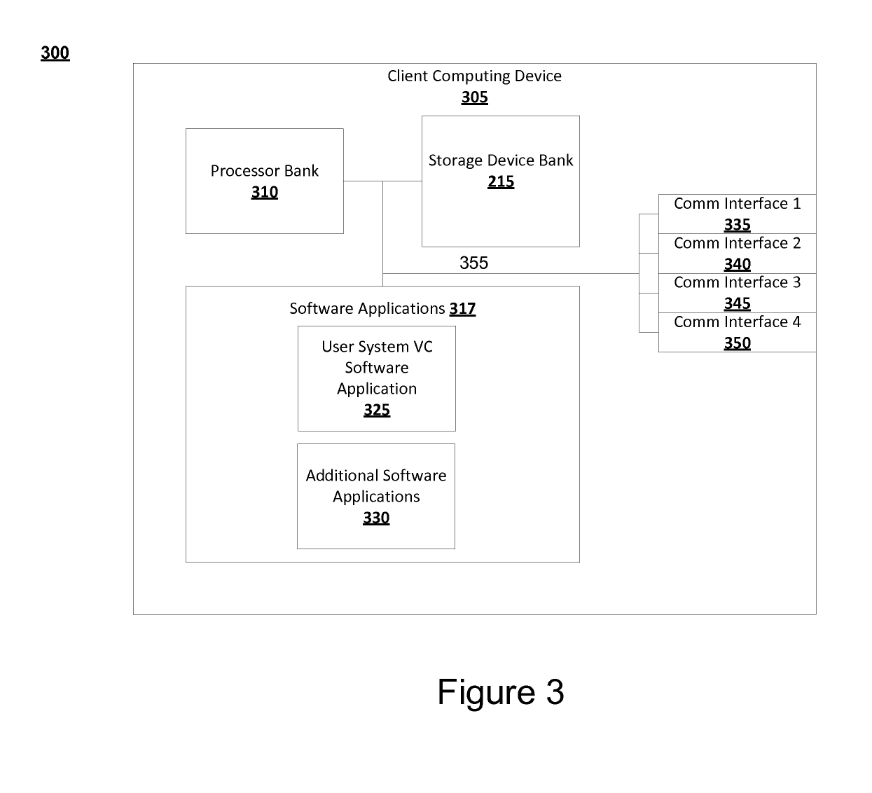

FIG. 3 is an exemplary functional block diagram 300 of a client computing device 305 used in implementing a software platform for purchasing, and managing one or more virtual collectibles. The client computing device 305 may include several different components such as a processor bank 310, storage device bank 315, one or more software applications 317, and one or more communication interfaces (335-350). The processor bank 310 may include one or more processors that may be co-located with each other or may be located in different parts of the client device 305. The storage device bank 315 may include one or more storage devices. Types of storage devices may include memory devices, electronic memory, optical memory, and removable storage media. The user VC software application 325 allows a user of the client computing device to purchase and manage one or virtual collectibles from a software platform residing on a computer server. The one or more software applications 317 may include additional software application 330 implementing software functions that assist in performing certain tasks for the client computing device 305 such as providing access to a communication network, executing an operating system, managing software drivers for peripheral components, and processing information. Additional software applications 330 may also include software drivers for peripheral components, user interface computer programs, debugging and troubleshooting software tools.

The user VC software application 325 may perform one or more functions. These may include interacting with a software platform on a computer server that has generated/manages a VC virtual marketplace. The VC software application 325 allows the user to view the user's own purchased or acquired VCs, manipulate and control the user's VCs, view other users' VCs including VCs available for sale by the owner of the VC virtual marketplace. Further, the VC software application 325 may generate, upon receiving input from the user (e.g. from a user interface), a purchase request to the VC virtual marketplace (e.g. the software platform that manages the VC virtual marketplace) to purchase a VC from another user of the VC virtual marketplace or from the owner virtual marketplace. In addition, VC software application 325 may generate, upon receiving input from the user (e.g. from a user interface), an access request to the VC virtual marketplace to manipulate controls the user's own VCs or to view another user's or available VCs to evaluate a possible purchase. Once access is granted by the software platform that manages the virtual platform, the VC software application 325 allows the user to control the VC indicated in the access request.

Each of the communication interfaces (335-350) shown in FIG. 3 may be software or hardware associated in communicating to other devices or to a computer server. The communication interfaces (335-350) may be of different types that include a user interface, USB, Ethernet, WiFi, WiMax, wireless, optical, cellular, or any other communication interface coupled to communication network.

An intra-device communication link 355 between the processor bank 310, storage device bank 315, software applications 317, and communication interfaces (335-350) may be one of several types that include a bus or other communication mechanism.

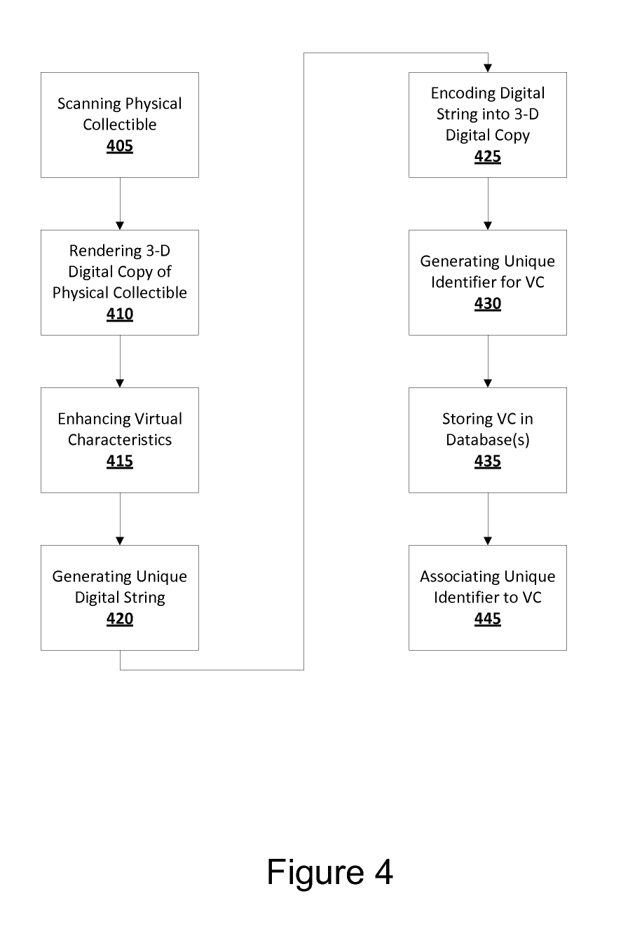

FIG. 4 is an exemplary flowchart showing an example method for generating a virtual collectible. A step in the example method may be scanning a physical collectible (e.g. action figure) using a scanning device, as shown in block 405, and rendering a 3-D digital copy of the physical collectible using a software platform, as shown in block 410. The software platform may include one or more software applications to implement aspects of VC generation, purchasing, and management. Such a software platform may reside and be executed on one or more computer servers. The scanning device used to scan the physical collectible may be coupled to the computer server executing the software platform (in a wired or wireless manner). Further, the software platform may enhance the virtual characteristics of the 3-D digital copy of the physical collectible, as shown in block 415. Such enhancements may include optimizing and texturing the 3-D digital copy of the physical collectible. In addition, the software platform may generate a unique digital string associated with the enhanced 3-D digital copy of the physical collectible, as shown in block 420. The unique digital string may be encrypted as well as may be based on the certain geometrical and texture, or other virtual characteristics of the 3-D digital copy of the physical collectible. Another step in the example method may be the software platform encoding the unique digital string into the 3-D digital copy of the physical collectible, as shown in block 425. A virtual collectible is the enhanced 3-D digital copy of the physical collectible encoded with the unique digital string. The unique digital string can be used to verify the authenticity of the virtual collectible. As discussed previously, value of physical collectibles increase with an increase degree of scarcity. Same may be true for virtual collectibles. Thus, the unique digital string for a certain type of VC may include the data that shows the number of VCs of that particular type. For example, an Optimus Prime action figure may be scanned to be a virtual collectible. The software platform may generate only 1,000 copies of the Optimus Prime VC. Thus, the unique digital string associated with each Optimus Prime VC may include data that shows that only 1,000 Cobra Commander VCs have been generated.

The VC may have several embodiments. One embodiment may include that the VC is rendered 360 degrees in 9 degree increments at two different resolutions (e.g. 100×100 pixels and 320×240 pixels). The file associated with the VC may be in a variety of formats such as PNG, GIF, or JPG. Further, VCs may be exported in different resolutions (e.g. polygonal mesh density) for varying levels of client device computing performance.

A further step in the example method may be the software platform generating a unique identifier for each type of VC, as shown in block 430. In addition, the software platform storing the VC in one or more electronic databases, as shown in block 435, and associating the unique identifier to the VC when storing the VC, as shown in block 445.

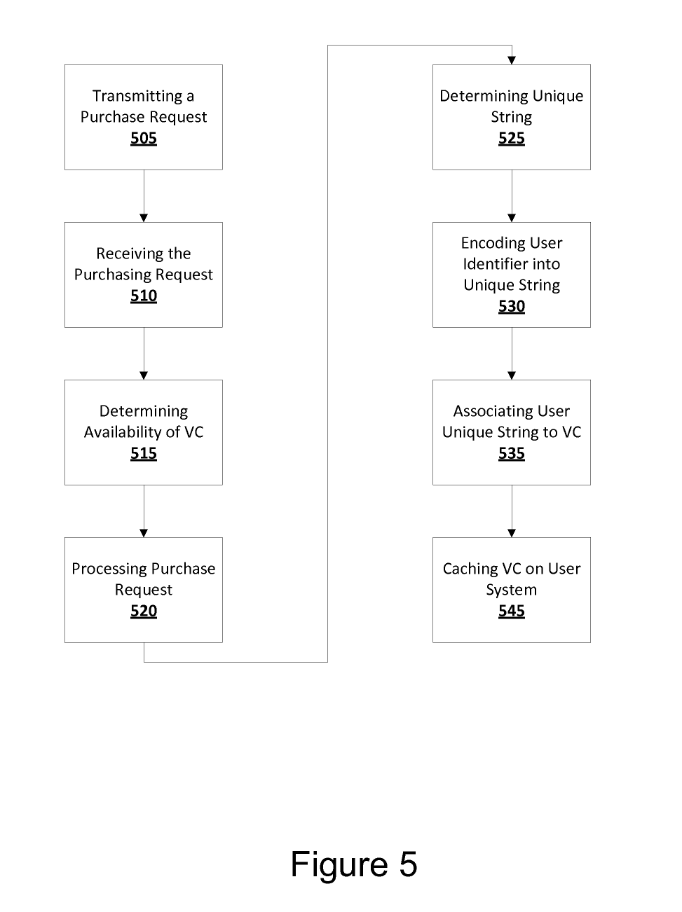

FIG. 5 is an exemplary flowchart showing an example method for purchasing a virtual collectible. A step in the example method may be a client computing device executing VC management software transmitting a purchase request to a computer server executing the VC software platform that generates VCs, facilitates purchasing and trading of VCs, and manages VCs, as shown in block 505. Further, the computer server receives the purchasing request through an application programming interface (API) from the client computing device, as shown in block 510. The software platform examines the request to determine the VC requested for purchase and the availability of the VC, as shown in block 515. If the VC is not available, then the software platform generates a response indicating the unavailability of the VC. For example, a particular VC may have only 1,000 copies and all of them were previously sold prior to receiving the pending purchase request. However, if the VC is available, the software platform processes the purchase request, as shown in block 520. In addition, the software platform determines or extracts the unique digital string from the VC that may be embedded in one of the virtual characteristics (e.g. primary texture), as shown in block 525. Further, a user identifier is encoded into the unique digital string resulting in a user unique string, as shown in block 530. Another step in the example method may be associating the user unique string to the VC, as shown in block 535. The unique user string and the record of the purchase are stored in one or more electronic databases and one unit for the VC purchased is deducted from the VC availability records. In addition, the VC is cached on the user system or client computing device so that it may be efficiently accessed by the user in the future, as shown in block 545.

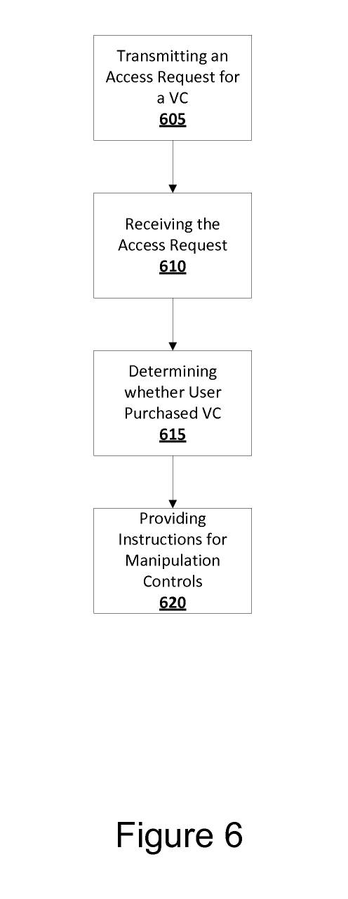

FIG. 6 is an exemplary flowchart showing an example method for managing or controlling a virtual collectible. A step in the example method may be user transmitting an access request for a VC using client VC software from a client computing device, as shown in block 605. Further, a VC software platform executed from a computer server may receive the access request from the client computing device, as shown in block 610. In addition, the software platform may process the access request t determine whether the user purchased the VC, as shown in block 615. If the user did purchase the VC, then the software platform provides instructions to the client software executing on the client computing device that the user may use an extensive set of controls to manipulate the VC, as shown in block 620. This may include arranging the VC within the user's collection of VCs. Alternatively, the user may view different perspectives of the 3-D image of the VC. Additionally, the user may manipulate the VC t interact with other VC in a virtual environment. However, if the user did not purchase the VC indicated in the access request, then the software platform provides instructions to the client software that the user may only use a subset of controls to manipulate the VC such as only viewing the 3-D image of the VC.

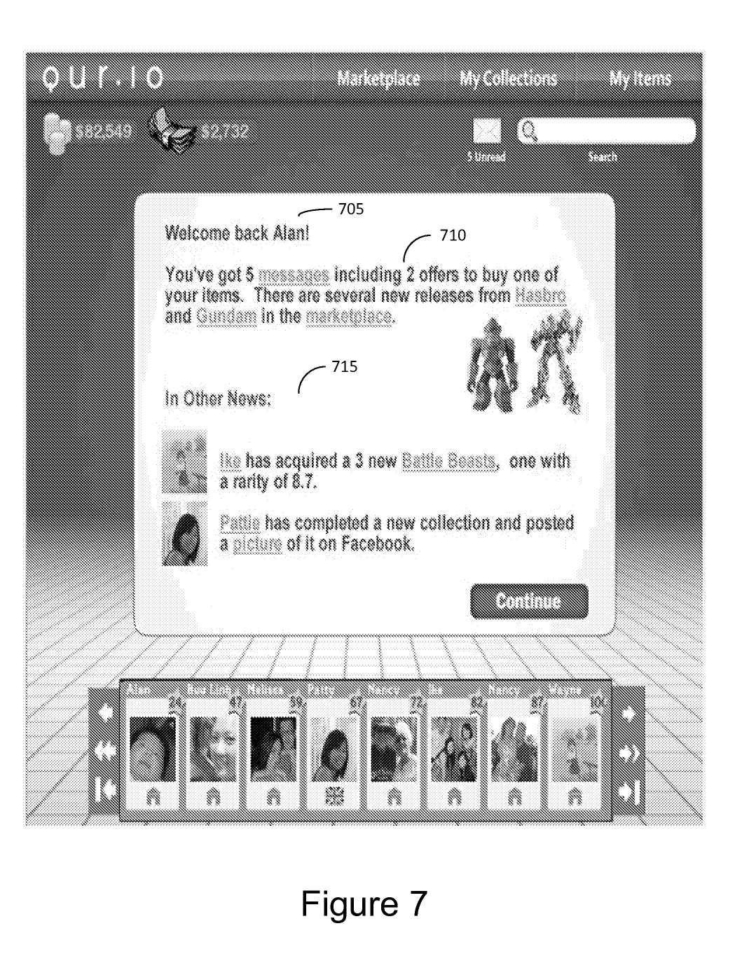

FIGS. 7-17 are exemplary screenshots of an example software platform and example client software for purchasing and managing virtual collectibles. Referring to FIG. 7, a user may access the exemplary screenshot shown from a client computing device. For example, a user may access the web page depicted in FIG. 7 from a laptop having some client VC software. Alternative embodiments may include a user access such an exemplary screenshot using a mobile software application from a mobile device (e.g. smartphone or tablet computer). Information provided on the screenshot is provided by a VC software platform executed on a computer server. The exemplary screenshot in FIG. 7 shows a welcome message to the user 705. Further, the software platform indicates any messages to the user that may include offers to by or new VC release information 710. In addition, the screenshot may indicate transaction activity by other users across the VC marketplace.

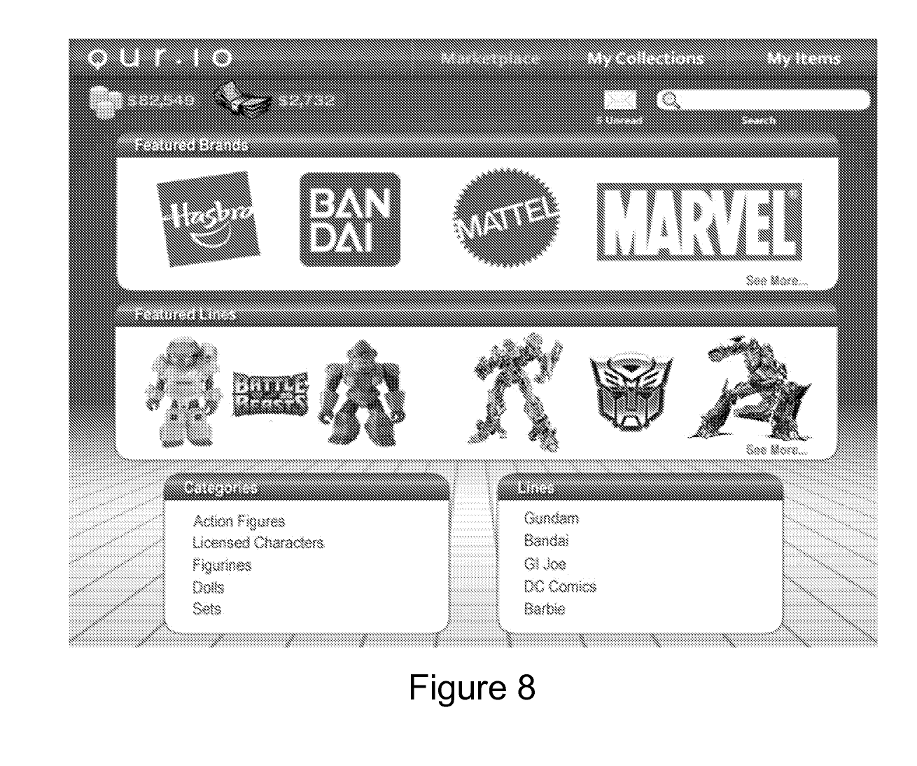

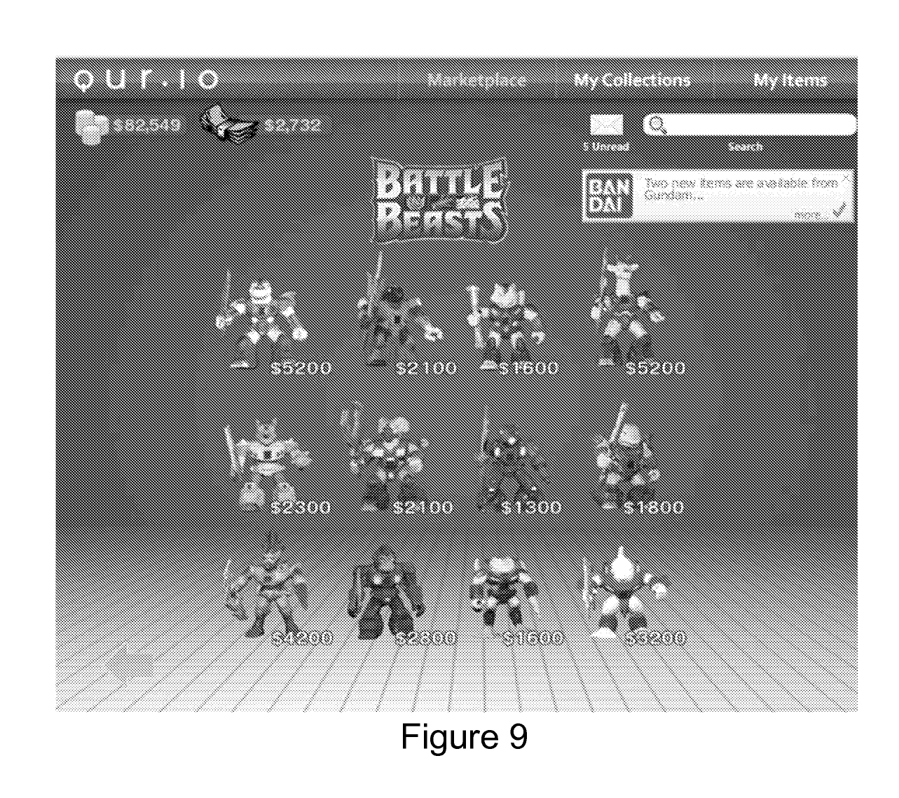

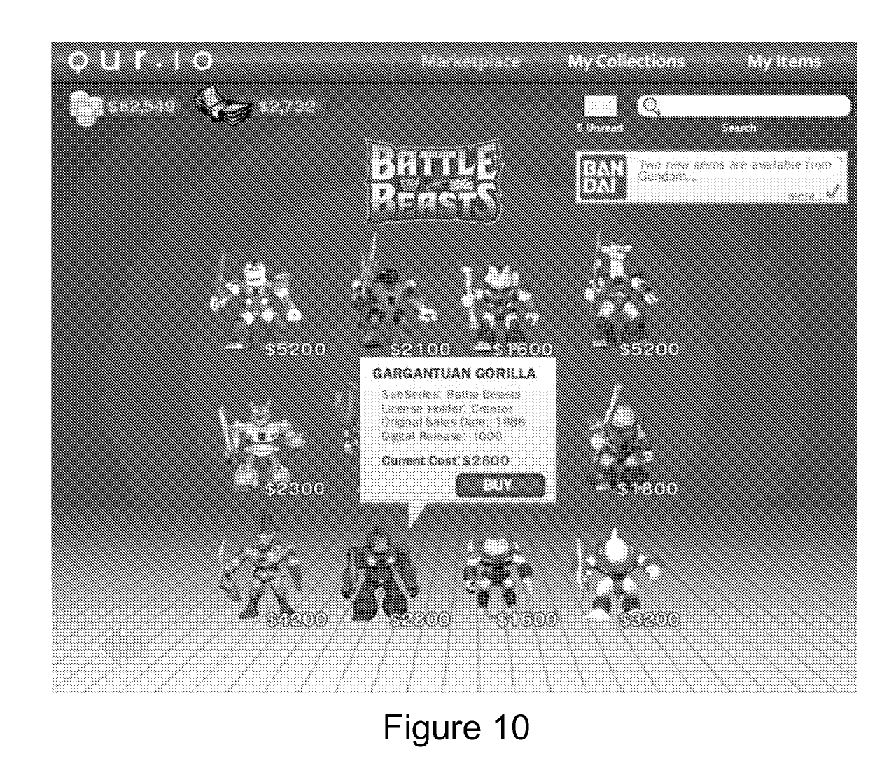

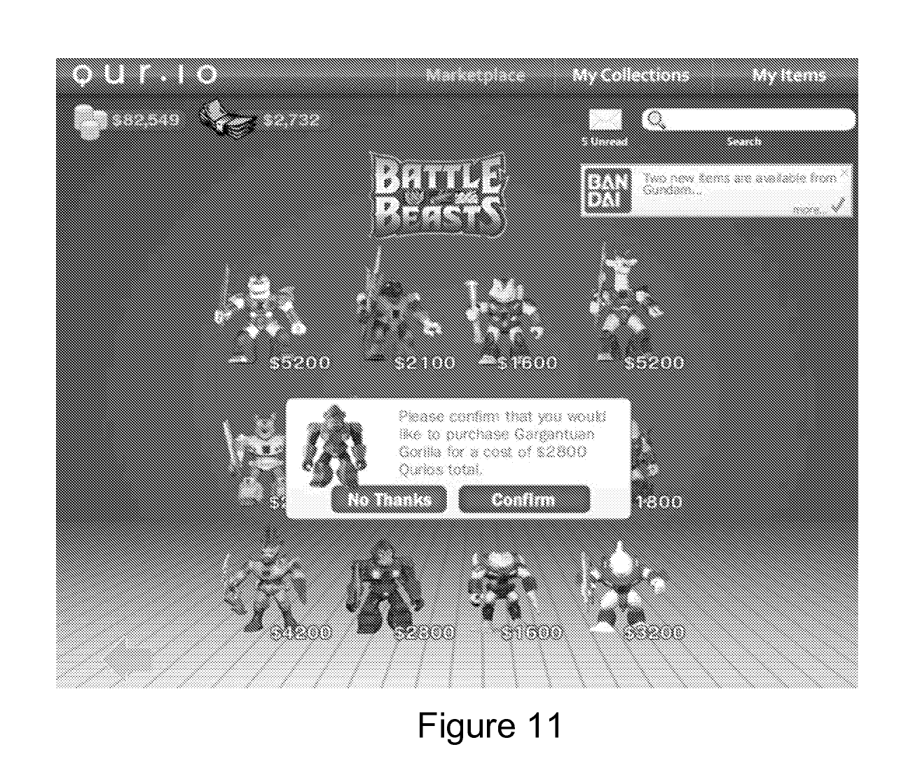

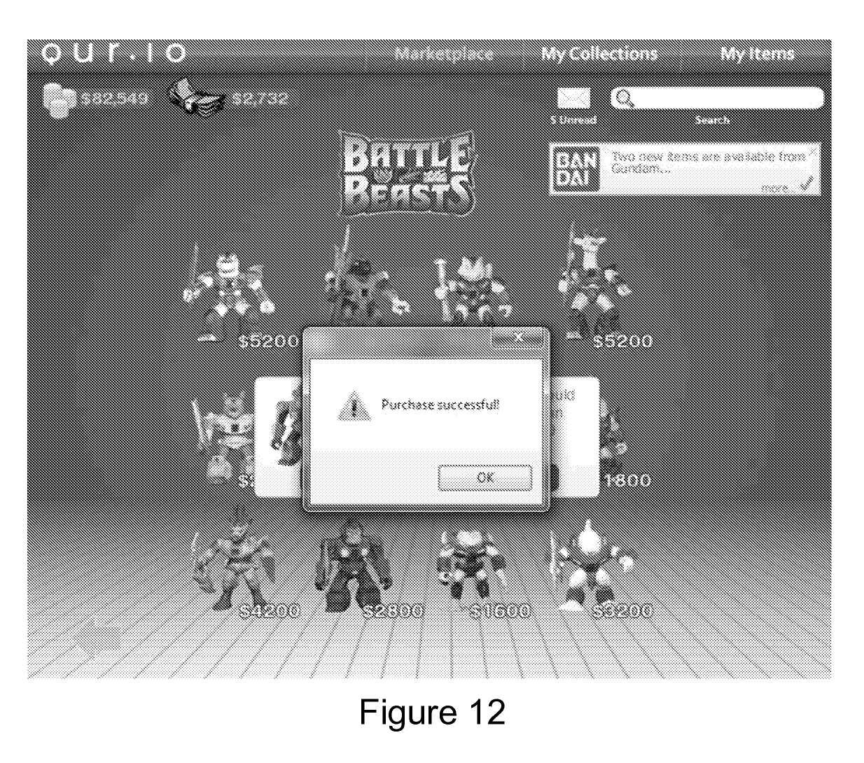

Referring to FIG. 8, the software platform provides display the different VCs available according the brands, lines and categories. Users may select to review any VC under such classifications by clicking various embedded links Referring to FIG. 9, a line of VCs is shown (e.g. Battle Beasts). Each VC in the line is shown to be available and the cost of purchasing each VC is also displayed. Referring to FIG. 10, a user may select a particular VC such that information regarding the VC is displayed. The software platform also provides the user an opportunity to buy the VC. Referring to FIG. 11, a user selects to buy the VC and the software platform provides a message to confirm or deny purchase. If the user confirms the purchase, the software platform displays a message that the purchase was successful as shown in FIG. 12.

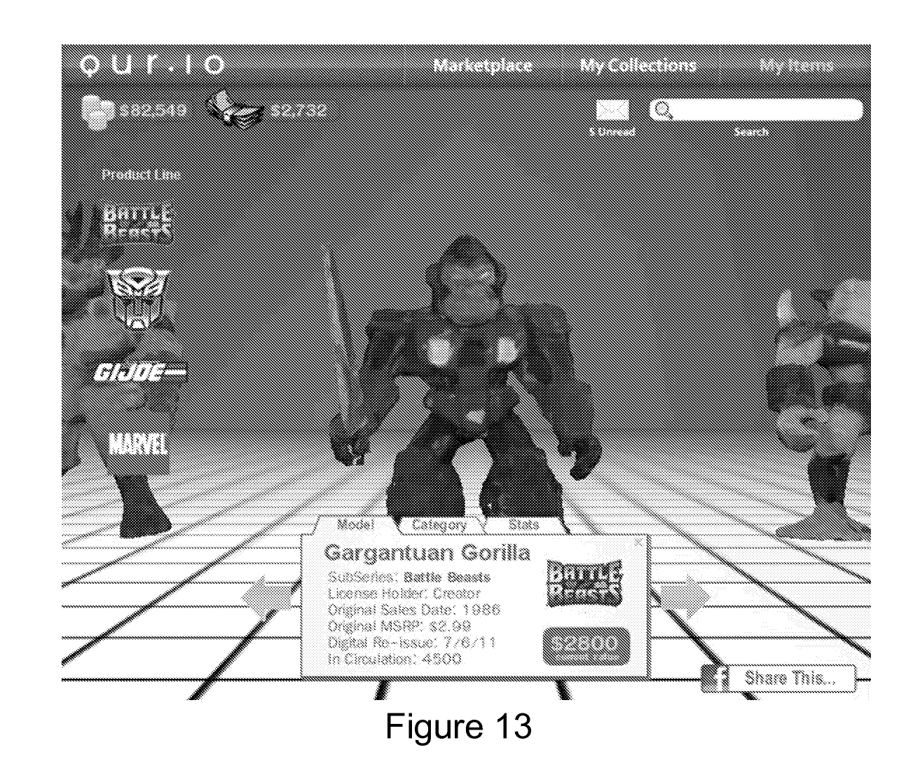

Referring to FIG. 13, a user may select to view more information of a VC. Such information may include model information, category classification information and statistics of the VC. Model information may include series information, the license holder, the original sales date, the original MSRP, the Digital Reissue or VC generation date, the number available or in circulation for the particular VC, and the current value of the VC. For example, in FIG. 13, the VC called Gargantuan Gorilla is part of the SubSeries Battle Beasts. The original sales date was in 1986 and the Original MSRP was $2.99. The VC generation or Digital Reissue date was Jul. 7, 2011 and there were 4,500 made available or in circulation. The current value of the Gargantuan Gorilla VC is $2,800.

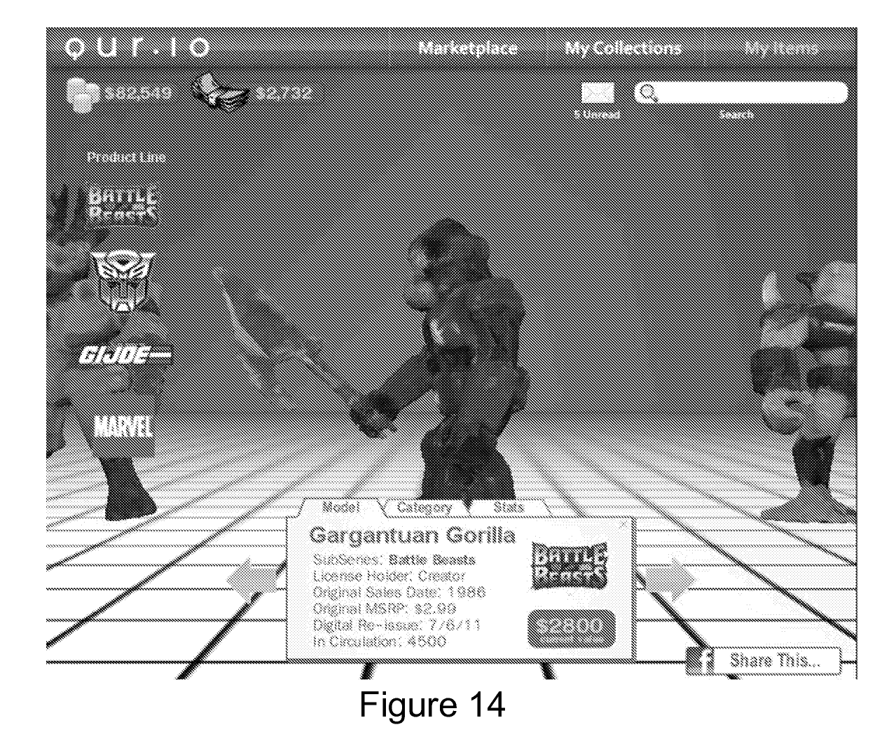

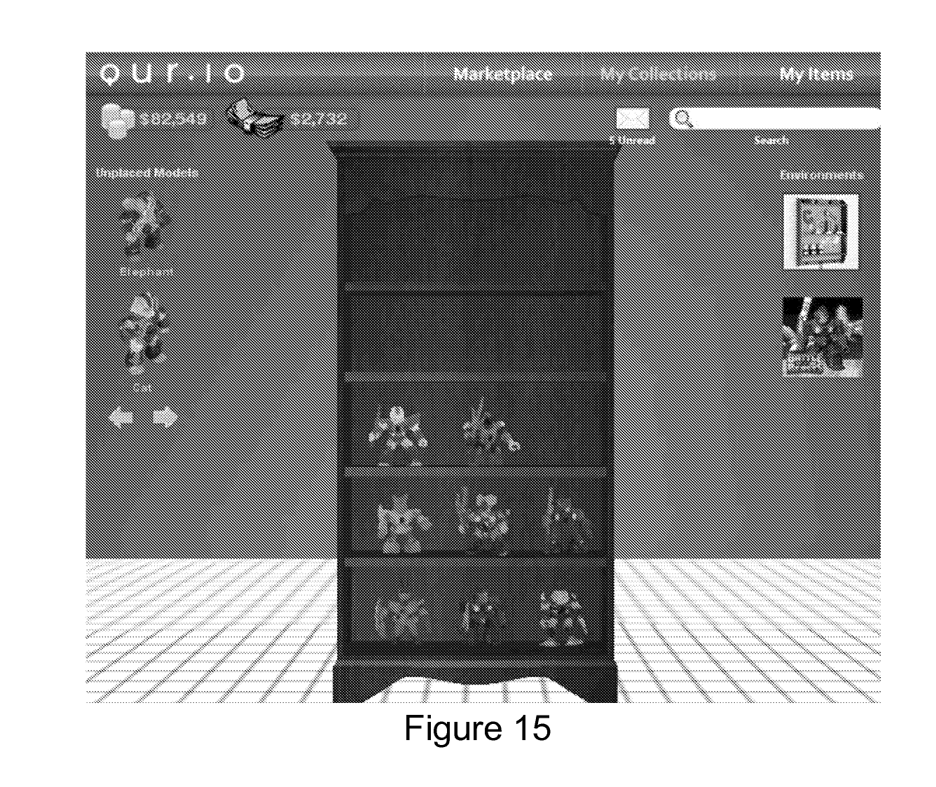

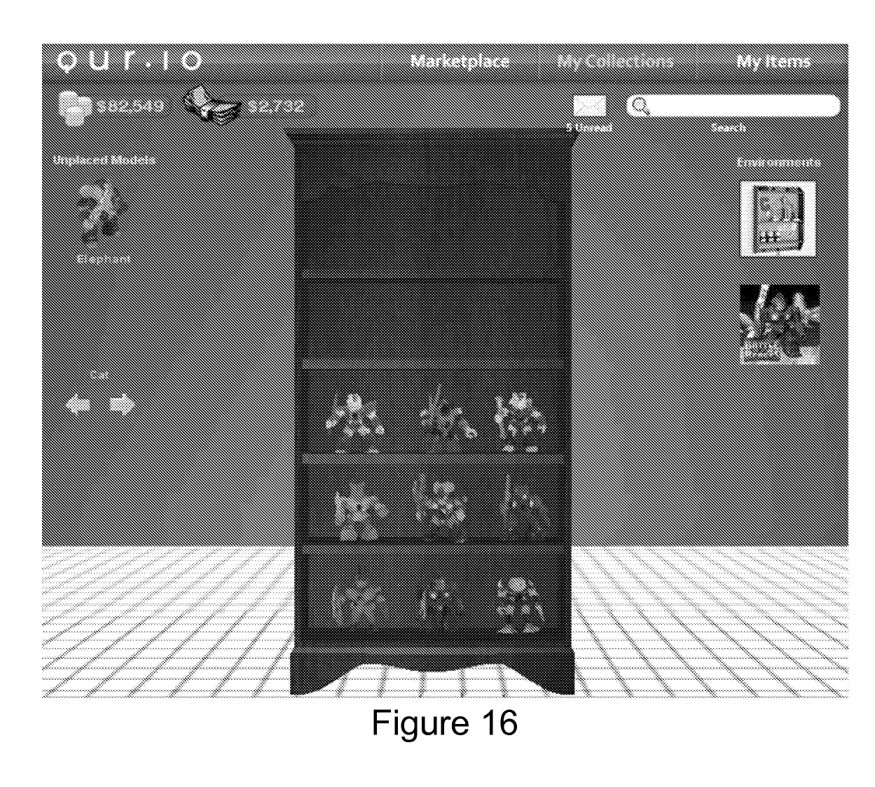

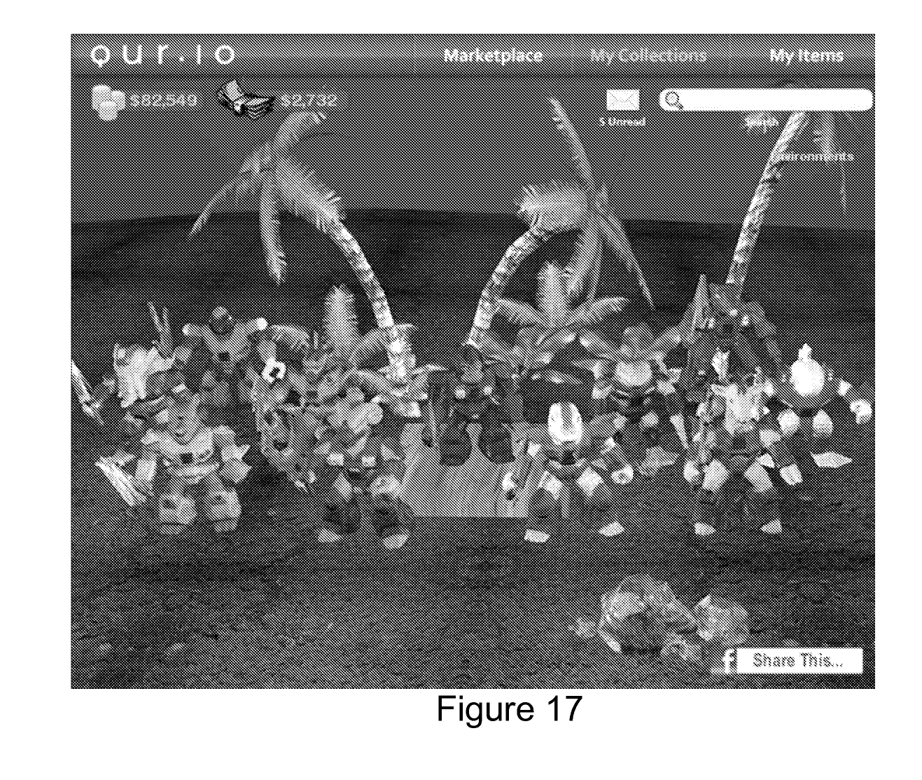

Referring to FIG. 14, the user may manipulate or otherwise control the VC in the virtual environment generated by the software platform. In FIG. 14, the user has manipulated the VC such that the left profile of the VC can be viewed. Referring to FIG. 15, the software platform may generate a virtual environment for a user to store or collect VCs. In FIG. 15, the software platform generates a virtual curio such that the user may place up to 3 VCs on each virtual shelf of the virtual curio. FIG. 16 shows a user adding another VC to the virtual curio. Referring to FIG. 17, the software platform generates a different virtual environment for the user to enjoy VCs. In such a virtual environment, the user may be able to manipulate more than one VC in a variety ways. For example, the user may be able to have one VC attack another or have one VC test its skills (e.g. strength, speed, agility, etc.) against another.

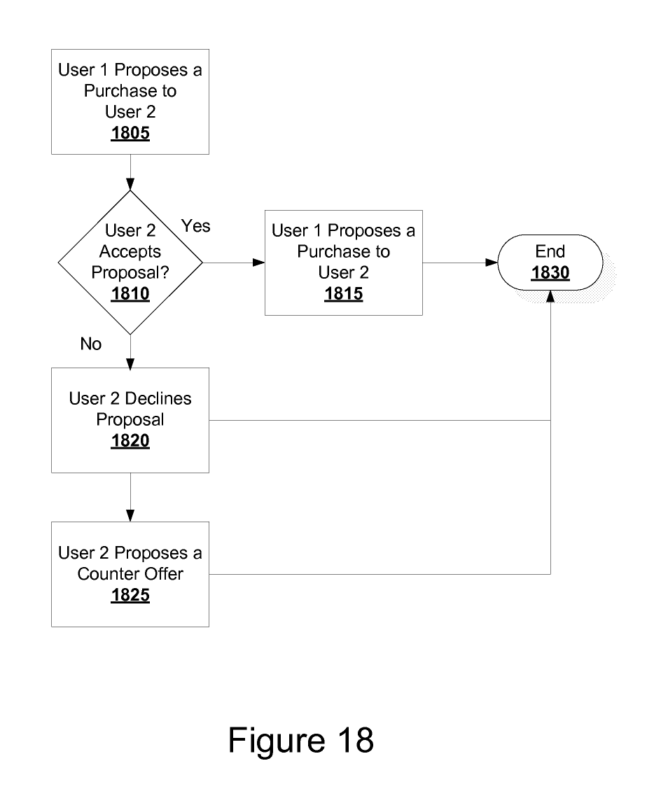

FIG. 18 is an exemplary flowchart that shows an embodiment of the virtual VC marketplace. At a step in the exemplary method, user 1 proposes a purchase of a VC owned by user 2, as shown in block 1805. User 1 may use a client VC software application on user 1's client computing device to make the proposal/request to user 2. The proposal/request may be sent to a computer server that supports a software platform generating the virtual VC marketplace. Further, the computer server relays the proposal/request to the client VC software application on user 2's client computing device After receiving, the proposal/request, User 2 may accept the proposal/request or not, as shown in block 1810. If user 2 accepts the proposal, as shown in block 1815. The software platform on the computer server that generates and manages the VC virtual marketplace completes the transaction. This may included extracting user 2's user ID from the unique user string embedded in the VC and then embedding the user ID of user 1 into the VC unique digital string to encode a new user unique string into the VC. Further, user 1 may not have a set of manipulation controls over the VC that allows user 1 to place the newly acquired VC in user 1's virtual cabinet or some other virtual environment generated/managed by the software platform executed on the computer server as part of the virtual VC marketplace. Alternatively, user 2 may decline the proposal/request from user 1 and the interaction between user 1 and user 2 may end, as shown in block 1820. As another alternative, user 2 may make a counter offer in a second proposal/request to user 1, as shown in block 1825. The software platform would relay such a second proposal/request from the client VC software application running on user 2's client computing device to the client VC software application running on user 1's client computing device. User 1 may then accept, decline, or make yet another counterproposal to user 2.

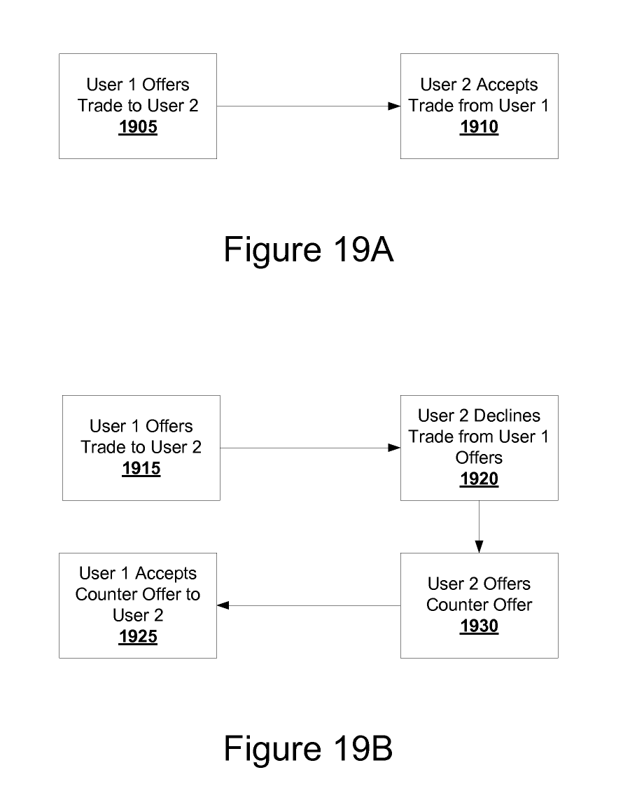

FIGS. 19A and 19B are other exemplary flowcharts that show other embodiments of the virtual VC marketplace. Referring to FIG. 19A, user 1 may make a trade offer to user 2, as shown in block 1905. Such a trade offer may be two VCs owned by user 1 whose total value may equal the value of one VC owned by user 2. Alternatively, user 1 may offer to trade one VC for a VC owned by user 2 of similar value. Such a trade offer may be generated by a client VC software application running on user 1's client computing device and relayed by a software platform on computer server that generates and manages a virtual VC marketplace to allow such trading of VCs between users. The software platform relays the trade offer to client VC software application running on user 2's client computing device. User 2, after reviewing the trade offer may accept the trade, as shown in block 1910.

Referring to FIG. 19B, user 1 may offer a trade for a VC to user 2 similar to as discussed in FIG. 19A, as shown in block 1915. However, user 2 may decline the trade, as shown in block 1920. Instead, user 2 may offer a counter offer or a trade of its own t user 1, as shown in block 1930. Such a counter offer may be relayed by the software platform from the client VC software running on the user 2 client computing device to the client VC software running on the user 1 client computing device. User 1 may receive the counter offer, and after review, accept the counteroffer from user 2, as shown in block 1925.

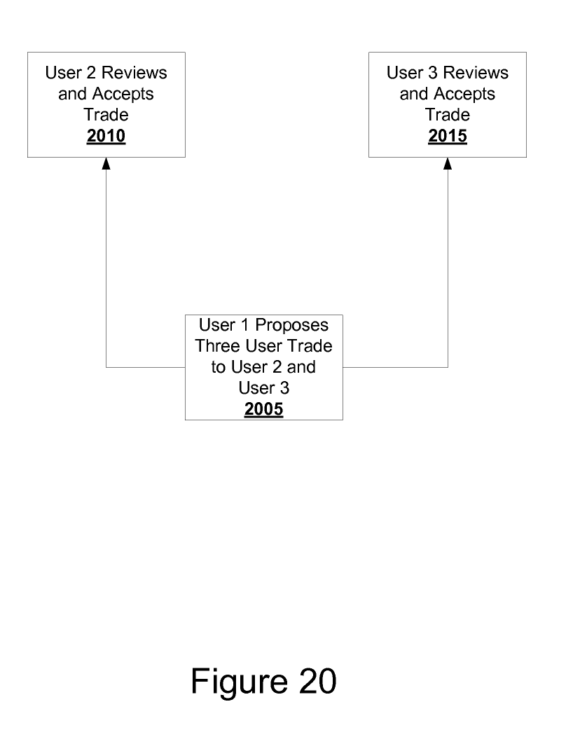

FIG. 20 is an exemplary flowchart that shows another embodiment of the virtual VC marketplace. User 1 may own a VC of a certain value. User 1 may then propose a trade such that user 1 trades a VC to user 2, user 2 trades a VC to user 3, and user trades a VC to user, as shown in block 2005. Such a proposal would be relayed from client VC software running on the user 1 client computing device to both client VC software running on the user 2 client computing device and the user 3 client computing device. This type of multi-user trade would be supported by a software platform generating and managing the VC virtual marketplace. User 2 and user 3 may review and accepts the trade to complete the transaction, as shown in block 2010 and 2015.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or an (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating a virtual collectible, the method comprising:
scanning a physical collectible using a scanning device;
rendering a three-dimensional (3-D) digital copy of the physical collectible using one or more software applications;
enhancing one or more virtual characteristics of the 3-D digital copy of the physical collectible using the one or more software applications;
generating a unique encrypted digital string based on the one or more virtual characteristics of the 3-D digital copy of the physical collectible using the one or more software applications;
encoding the unique digital string into one of the one or more virtual characteristics of the 3-D digital copy of the physical collectible wherein the virtual collectible is the enhanced 3-D digital copy of the physical collectible encoded with the unique digital string.

2. The method of claim 1, the method further comprising rendering one or more 3-D digital copies of the physical collectible using one or more software application wherein each of the one or more 3-D digital copies having a different set of one or more virtual characteristics.

3. The method of claim 1, the method further comprising:
generating a unique identifier for the virtual collectible using one or more software applications;
storing the virtual collectible in one or more databases;
associating the unique identifier to the virtual collectible using one or more software applications.

4. A system for generating and managing a virtual marketplace for virtual collectibles (VC), the system comprising:
a communication network;
one or more electronic databases coupled to the communication network;
a software platform including one or more server software applications coupled to the communication network;
one or more client computing devices having a client VC software application, the one or more client computing devices coupled to the communication network;
wherein the software platform (i) generates one or more virtual collectibles; (ii) allows one or more users from each user's corresponding client computing device, to purchase at least one of the one or more virtual collectibles; (iii) generates one or more virtual environments; (iv) allows each user to control a purchased virtual collectible in the one or more virtual environments.

5. The system of claim 4, wherein the software platform (i) receives a purchase request from a first user client VC software application to purchase a virtual collectible; (ii) processes the purchase request; and (iii) provide owner control instructions to first user client VC software application for the purchased virtual collectible.

6. The system of claim 4, wherein the software platform (i) receives a purchase request from a first user client VC software application to purchase a virtual collectible from a second user; (ii) relays the purchase request to a second user client VC software application; (iii) receives a purchase confirmation from second user client VC software application; (iv) processes the purchase request; and (v) provide owner control instructions to first user client VC software application with regard to the purchased virtual collectible.

7. The system of claim 4, wherein the software platform (i) receives a trade offer from a first user client VC software application to trade one or more VCs between the first user and a second user; (ii) relays the trade offer to a second user client VC software application.

8. The system of claim 7, wherein the software platform (i) receives a trade confirmation from second user client VC software application; (ii) processes the trade request; and (ii) provide new owner control instructions to first user client VC software application and second user client VC software application for the traded virtual collectibles.

9. The system of claim 6, wherein the software platform (i) receives a countertrade request from second user client VC software application; (ii) relays the countertrade request to first user client VC software application; (iii) receives a counter trade confirmation from first user client VC software application; (iv) processes the countertrade request; and (v) provide new owner control instructions to first user client VC software application and second user client VC software application for the traded virtual collectibles.

10. The system of claim 4, wherein the software platform (i) receives a trade offer from a first user client VC software application to trade one or more VCs between a set of users; (ii) relays the trade offer to a client VC software application corresponding to each user in the set of user; (iii) receives a trade confirmation from client VC software application corresponding to each user in the set of users; (ii) processes the trade request; and (ii) provide new owner control instructions to client VC software application corresponding to each user in the set of users and for the traded virtual collectibles.

11. A system for managing one or more virtual collectibles, the system comprising:
communication network
a computer server executing a software platform including one or more software applications;
one or more electronic databases for storing the one or more virtual collectibles, the one or more electronic databases coupled to the computer server across the communication network;
a scanning device coupled to the computer server wherein the scanning device receiving a scanned image of a physical collectible;
wherein the software platform: (i) renders a three-dimensional (3-D) digital copy of the physical collectible; (ii) enhances one or more virtual characteristics of the 3-D digital copy of the physical collectible; (iii) generates a unique encrypted digital string based on the one or more virtual characteristics of the 3-D digital copy of the physical collectible; (iv) encodes the unique digital string into one of the one or more virtual characteristics of the 3-D digital copy of the physical collectible wherein the virtual collectible is the enhanced 3-D digital copy of the physical collectible encoded with the unique digital string.

12. The system of claim 11, wherein the software platform renders one or more 3-D digital copies of the physical collectible, each of the one or more 3-D digital copies having a different set of one or more virtual characteristics.

13. The system of claim 11, wherein the software platform: (i) generates a unique identifier for the virtual collectible; (ii) stores the virtual collectible in one or more electronic databases; and (iii) associating the unique identifier to the virtual collectible.

14. The system of claim 11, further comprising:
a user system executing a client software platform including one or more client software applications coupled to the computer server across the communication network;
wherein the client software platform transmits a purchase request for the virtual collectible.

15. The system of claim 14, wherein the software platform: (i) receives the purchase request of the virtual collectible from an application programming interface, the purchase request associated with a user; (ii) determines the availability of the virtual collectible by analyzing one or more electronic databases; (iii) processes the purchase request for the virtual collectible; (iv) determines a unique string associated with the virtual collectible; (iv) encodes user identifier information with the unique string to generate a user unique string for the virtual collectible; (v) associates the user unique string to the virtual collectible.

16. The system of claim 15, wherein the software platform stores the user unique string and purchase information associated with the virtual collectible in one or more databases.

17. The system of claim 15, wherein the software platform modifies inventory associated with the virtual collectible based on the processing of the purchase request.

18. The system of claim 15, the software platform providing instructions to cache the virtual collectible on the user system using one or software applications.

19. The system of claim 15, wherein the user system sends a request from the user to access the virtual collectible and the software platform: (i) receives the request from the user to access the virtual collectible from the application programming interface; (ii) determines whether the user has purchased the virtual collectible based on the user unique string.

20. The system of claim 19, wherein the software platform
determining whether the virtual collectible is purchased by the user;
providing instructions to a user system to allow the user access to manipulation controls for the virtual collectible based on whether the virtual collectible is purchased by the user.
